(19) United States
(12) Patent Application Publication
(10) Pub. No.: US 2026/0140516 A1
(43) Pub. Date: May 21, 2026

(54) ROBOT, SERVER, AND METHOD FOR CONTROLLING SAME

(71) Applicant: LG ELECTRONICS INC., Seoul (KR)

(72) Inventor: Seungwon LEE, Seoul (KR)

(73) Assignee: LG ELECTRONICS INC., Seoul (KR)

(21) Appl. No.: 19/118,313

(22) PCT Filed: Aug. 1, 2023
(86) PCT No.: PCT/KR2023/011232

§ 371 Date: Apr. 3, 2025

(30) Foreign Application Priority Data
Oct. 6, 2022 (KR) 10-2022-0127724

(51) Int. Cl. G05D 1/69; G05D 1/246; G05D 105/28

(52) U.S. Cl. CPC G05D 1/69; G05D 1/246; G05D 2105/28

(57) ABSTRACT

A method for controlling a robot that communicates with a server, according to an embodiment of the present disclosure, comprises the steps of: driving on the basis of a map comprising a plurality of areas; and, prior to entering any area, transmitting a request to the server for permission to enter the area and information on lanes to be travelled in the area; and, receiving, from the server, permission to enter the area and the information on lanes to be travelled in the area.

### TECHNICAL FIELD

The present disclosure relates to a robot. In particular, the present disclosure relates to an algorithm that changes a map, which is a basis of a path on which a plurality of robots travel, in real time in a cloud environment.

### BACKGROUND

Because of influence of COVID-19 pandemic or the like, more and more workplaces are replacing humans with robots in various environments.

For example, a specialized logistics robot or the like that loads a large amount of items at the rear of a main body of the robot and transports the items to a destination is being used. In addition, research on an automated guided vehicle (AGV) that moves along a predetermined movement line, an autonomous mobile robot (AMR) that moves by finding a path by itself, and the like is continuously being conducted.

However, according to the prior art, the robot is designed to move along a predetermined movement line in a distribution center. Generally, the robot moves in the distribution center via two lanes.

However, because there are many loaded loads in the distribution center, when the robot is designed to always move in the two lanes, an accident in which the robot collides with the loaded loads may occur unexpectedly, and a time at which the robot arrives at the destination may be delayed.

### SUMMARY

### Technical Problem

The present disclosure is to solve the above problems, and proposes an algorithm for managing, in a divided manner, a map used when two or more robots cross each other in a specific area and a map when only one robot travels, in a narrow space (e.g., a space in which two robots may cross each other or the like) of a distribution center, and using a specific map among the above-described maps dynamically or adaptively depending on a situation.

It is also within the scope of the present disclosure for those skilled in the art to implement another embodiment by referring to the entire present document.

### Technical Solutions

A method for controlling a server according to an embodiment of the present disclosure includes creating a map where at least one robot is movable, identifying the created map as at least one area, receiving, from the at least one robot, a request for a permit to enter an arbitrary area and information on a lane where the at least one robot is to move in the corresponding area, and transmitting, to the robot that has transmitted the request, the permit to enter the arbitrary area and the information on the lane where the robot is to move in the corresponding area.

The method may, for example, further include receiving location information and destination information from all robots using the map.

The method may, for example, further include determining whether to permit the robot that has transmitted the request to enter the arbitrary area and the information on the lane where the robot is to move in the corresponding area, based on the received location information and destination information.

The method may further include, when it is determined that the robot that has transmitted the request will travel alone in the arbitrary area, generating a command for controlling the robot to use one lane located at a center of the arbitrary area of the map.

The method may further include, when it is determined that another robot besides the robot that has transmitted the request will also travel together in the arbitrary area, generating a command for controlling one of two lanes not located at the center of the arbitrary area of the map to be used.

A server according to an embodiment of the present disclosure includes a controller that creates a map where at least one robot is movable, and identifies the created map as at least one area, and a network interface that receives, from the at least one robot, a request for a permit to enter an arbitrary area and information on a lane where the at least one robot is to move in the corresponding area, and transmits, to the robot that has transmitted the request, the permit to enter the arbitrary area and the information on the lane where the robot is to move in the corresponding area.

The network interface may, for example, receive location information and destination information from all robots using the map.

The controller may, for example, determine whether to permit the robot that has transmitted the request to enter the arbitrary area and the information on the lane where the robot is to move in the corresponding area, based on the received location information and destination information.

The controller may, for example, when it is determined that the robot that has transmitted the request will travel alone in the arbitrary area, generate a command for controlling the robot to use one lane located at a center of the arbitrary area of the map.

The controller may, for example, when it is determined that another robot besides the robot that has transmitted the request will also travel together in the arbitrary area, generate a command for controlling one of two lanes not located at the center of the arbitrary area of the map to be used.

A method for controlling a robot in communication with a server according to an embodiment of the present disclosure includes traveling on a map composed of a plurality of areas, transmitting, to the server, a request for a permit to enter an arbitrary area and information on a lane where the robot is to move in the arbitrary area before entering the arbitrary area, and receiving, from the server, the permit to enter the arbitrary area and the information on the lane where the robot is to move in the corresponding area.

The method may further include transmitting, to the server, current location information and destination information in the map.

The method may further include, depending on a state of the arbitrary area, traveling in one lane located at a center of the arbitrary area of the map.

The method may further include, depending on the state of the arbitrary area, traveling in one of two lanes not located at the center of the arbitrary area of the map.

The state of the arbitrary area may, for example, vary based on the number of robots to simultaneously travel or stop in the arbitrary area.

A robot in communication with a server according to an embodiment of the present disclosure includes a controller that controls the robot to travel on a map composed of a plurality of areas, and a network interface that transmits, to the server, a request for a permit to enter an arbitrary area and information on a lane where the robot is to move in the arbitrary area before entering the arbitrary area, and receives, from the server, the permit to enter the arbitrary area and the information on the lane where the robot is to move in the corresponding area.

The network interface may, for example, transmit, to the server, current location information and destination information in the map.

The controller may, for example, depending on a state of the arbitrary area, control the robot to travel in one lane located at a center of the arbitrary area of the map.

The controller may, for example, depending on the state of the arbitrary area, control the robot to travel in one of two lanes not located at the center of the arbitrary area of the map.

The state of the arbitrary area may, for example, vary based on the number of robots to simultaneously travel or stop in the arbitrary area.

### Advantageous Effects

According to an embodiment of the present disclosure, the technical effect is expected in which the robot may more quickly pass through the specific area in the map via the communication with the server in the particularly narrow area even in the distribution center.

Furthermore, according to another embodiment of the present disclosure, the possibility of the robot colliding with the loaded load when moving inside the distribution center may be greatly reduced.

An additional range of applicability of the present disclosure will become apparent from the following detailed description.

However, because various changes and modifications within the spirit and the scope of the present disclosure may be clearly understood by those skilled in the art, it should be understood that the detailed description and a specific embodiment such as a preferred embodiment of the present disclosure are given only by way of example.

### BRIEF DESCRIPTION OF THE DRAWINGS

FIG. 1 illustrates a map related to a traveling path of a robot using only determined and fixed lanes according to the related art.

FIG. 2 is a view for illustrating an outer appearance of a robot according to an embodiment of the present disclosure and a problem that may occur when the lanes illustrated in FIG. 1 are used.

FIG. 3 is a block diagram illustrating internal components of the robot illustrated in FIG. 2.

FIG. 4 illustrates a modified map according to an embodiment of the present disclosure.

FIG. 5 illustrates an example of a server in communication with a robot according to an embodiment of the present disclosure.

FIG. 6 is a diagram illustrating that a full map on which a robot travels is subdivided into a plurality of areas according to an embodiment of the present disclosure.

Further, FIG. 7 illustrates a process in which a robot switches map information in a specific area according to an embodiment of the present disclosure.

### BEST MODE

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

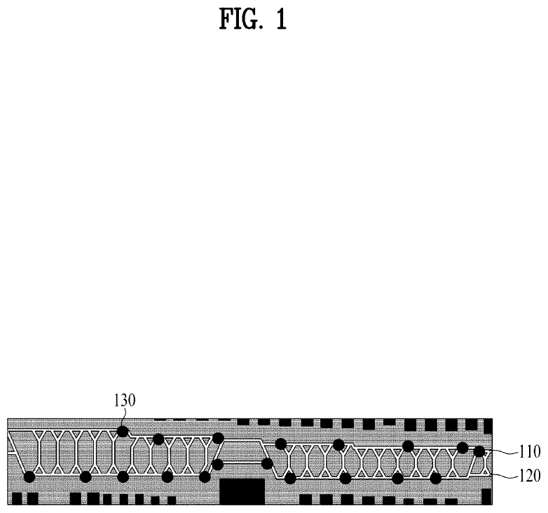

FIG. 1 illustrates a map related to a traveling path of a robot using only determined and fixed lanes according to the related art.

According to the related art, a map is generated such that a robot 130 travels in lanes of both upper and lower ends 110 and 120 for the robot 130 to cross in a narrow space (a space in which two robots may cross) such as a distribution center.

That is, according to the related art, as shown in FIG. 1, when the two-lane road 110 and 120 is generated, the robot should unconditionally move in the upper lane 110 or the lower lane 120.

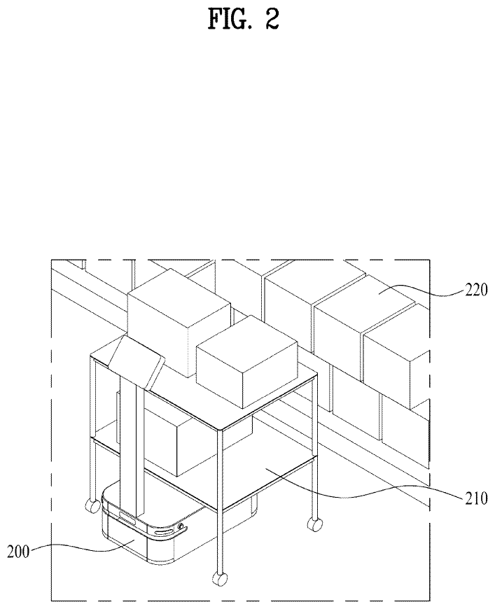

However, there are several problems in designing that, even when only one robot travels in a specific area, the robot travels in both ends 110 and 120. The problems related thereto will be described in more detail with reference to FIG. 2.

FIG. 2 is a view for illustrating an outer appearance of a robot according to an embodiment of the present disclosure and a problem that may occur when the lanes illustrated in FIG. 1 are used.

First, as shown in FIG. 2, a robot 200 according to an embodiment of the present disclosure may attach a carrier 210 or the like thereto to move loads in the distribution center to an arbitrary location.

However, as shown in FIG. 2, a number of loads 220 are stacked on the traveling path in the distribution center. Therefore, when the robot uses only the both end lanes 110 and 120 shown in FIG. 1, a possibility of colliding with the loads 220 shown in FIG. 2 increases.

Because a lot of other items are typically placed at an end of a corridor in the distribution center, in a special situation in which only one robot moves in an arbitrary area, it will be desirable to move the robot to a new lane at a center rather than at the end of the corridor and allow the robot to travel therein.

Therefore, according to an embodiment of the present disclosure, it is designed to determine how many robots are traveling in each area of the distribution center, and when only one robot moves in an arbitrary area, switch to a map that may use the center of the corridor.

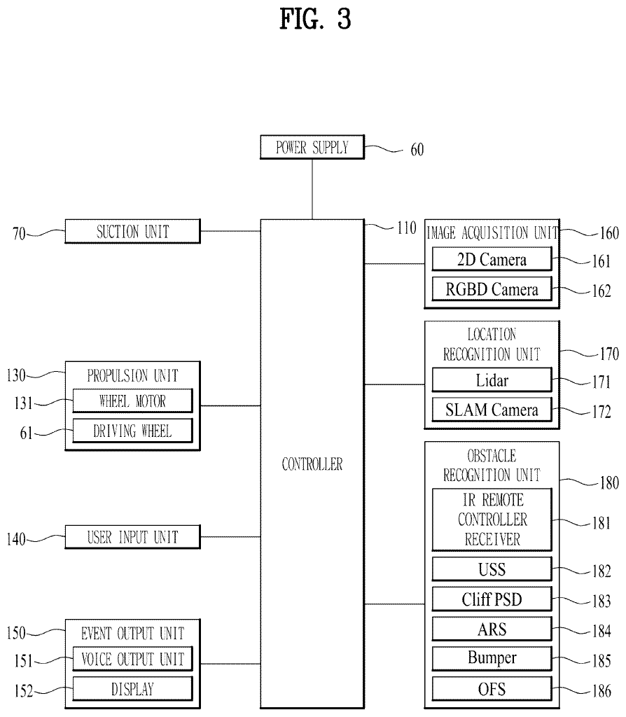

Detailed components of the robot 200 shown in FIG. 2 for implementing the above will be described in detail with reference to FIG. 3.

FIG. 3 is a block diagram illustrating internal components of the robot illustrated in FIG. 2.

A robot illustrated in FIG. 3 may be connected to a server via a communication technology (e.g., 5G or the like), and may transmit and request necessary information to the server and provide the same to a user.

A suction unit 70 serves to suck air around the robot and detect fine dust or the like.

Furthermore, the robot may directly receive a command from the user. For example, a command may be directly received from the user via an input of touching a display 152 equipped on the robot, a voice input, or the like.

In one example, a voice output unit 151 that outputs an event occurred in the robot via a voice and the above-described display 152 may be referred to as an event output unit 150.

When a voice is input, the robot activates a voice recognition function in response to a wake-up word uttered by the user, and a voice command received from the user is transmitted to the connected server via an AI processor installed in the robot or a 5G communication technology and is recognized, so that the robot operates to perform the specific task requested by the user.

The robot, as a robot including an 3D depth sensor, an RGB camera, and an odometry (a wheel encoder, a gyro sensor, and the like) capable of estimating a travel distance, may be defined as an autonomous mobile robot that is free to move in a space within an area.

The processor 110 may include a power supply 60 including a battery or the like among hardware of the robot, an obstacle recognition unit 180 including various sensors, and a microcomputer that manages a propulsion unit 130 including a plurality of motors and wheels.

In addition, the processor 110 may include an application processor (AP) that performs a function of managing an entire system of a hardware module of the robot. The AP performs application program movement for travel using location information obtained via the various sensors, and movement of the motor or the like by transmitting user input/output information to the microcontroller. In addition, a user input unit 140, an image acquisition unit 160, a location recognition unit 170, and the like may be managed by the AP.

In addition, the processor 110 may include an AI processor. The AI processor may learn a neural network using a program stored in a memory. In particular, the AI processor may learn the neural network for recognizing data around the robot. In this regard, the neural network may include a deep learning model developed from a neural network model. In the deep learning model, a plurality of network nodes may exchange data based on a convolution connection relationship while being located in different layers. Examples of the neural network model may include various deep learning techniques such as a deep neural network (DNN), a convolutional deep neural network (CNN), a recurrent Boltzmann machine (RNN), a restricted Boltzmann machine (RBM), a deep belief network (DBN), and a deep Q-network, and the neural network model may be applied to fields such as computer vision, voice recognition, natural language processing, voice/signal processing, and the like.

The robot may implement at least one function among voice recognition, object recognition, location recognition, obstacle recognition, and/or movement control by applying the deep learning model via the AI processor. In addition, the robot may implement the above-described at least one function by receiving an AI processing result from an external server via a communication unit.

The power supply 60 may include a battery driver and a lithium-ion battery. The battery driver may manage charging and discharging of the lithium-ion battery. The lithium-ion battery may supply power for the movement of the robot. The lithium-ion battery may be built by connecting two 24V/102 A lithium-ion batteries in parallel with each other.

The communication unit (not shown) may further include various additional components such as a wireless communication module (not shown) for wireless communication or a tuner (not shown) for tuning a broadcast signal based on a design method of the robot, as well as a component that receives a signal/data from an external input. In addition to receiving the signal from an external device, the communication unit may transmit information/data/signal of the robot to the external device. That is, the communication unit may not be limited only as a component that receives the signal of the external device, and may be implemented as an interface capable of bidirectional communication. The communication unit may receive a control signal for selecting a UI from a plurality of control devices. The communication unit may be equipped as a communication module for known short-range wireless communication such as wireless LAN (WiFi), Bluetooth, Infrared (IR), Ultra Wideband (UWB), Zigbee, or the like, may be equipped as a mobile communication module using 3G, 4G, LTE, 5G, or the like, or may be equipped as a known communication port for wired communication. The communication unit may be used for various purposes, such as a command for manipulating the display and transmission and reception of data, in addition to the control signal for selecting the UI.

The propulsion unit 130 may include a wheel motor 131, a driving wheel 61, and the like. The wheel motor 131 may move the plurality of wheels for the travel of the robot. A rotation motor may be moved for rotation in a left and right direction and rotation in a vertical direction of a main body of the robot or a head of the robot, or may be moved for direction change or rotation of the wheels of the robot.

In one example, in a case of a robot programmed to perform a specific function, an additional function of the propulsion unit for performing the specific function may be provided.

The user input unit 140 transmits various preset control commands or information to the processor 110 based on a manipulation and an input of the user. The user input unit 140 may be implemented as a menu-key or an input panel installed on an outer side of the display device, or a remote controller or the like separated and spaced apart from the robot. Alternatively, the user input unit 140 may be integrally implemented with the display (not shown). When the display is a touch screen, the user may transmit the preset command to the processor 110 by touching an input menu (not shown) displayed on the display.

The user input unit 140 may sense a user's gesture via a sensor that senses inside of the area and transmit the user's command to the processor 110, and may transmit the user's voice command to the processor 110 to perform operation and setting.

The image acquisition unit 160 may include a 2D camera 161 and an RGBD camera 162. The 2D camera 161 may be a sensor for recognizing a person or an object based on a 2D image. The red, green, blue, distance (RGBD) camera 162 may be a sensor for tracking the person or the object using captured images having depth data obtained from a camera with RGBD sensors or other similar 3D imaging devices.

The location recognition unit 170 may include a Lidar 171 and a SLAM camera 172. The simultaneous localization and mapping (SLAM) camera 172 may implement same-time location tracking and mapping technology. Using the SLAM camera 172, the robot may track surrounding environment information, process the obtained information to create a map corresponding to a duty execution space, and estimate an absolute location thereof at the same time. The light detection and ranging (Lidar) 171, as a laser radar, may be a sensor that irradiates a laser beam and collects and analyzes backscattered light of light absorbed or scattered by an aerosol to perform the location recognition. The location recognition unit 170 may handle and process sensing data collected from the Lidar 171, the SLAM camera 172, and the like to be in charge of data management for the location recognition and the obstacle recognition of the robot.

The obstacle recognition unit 180 may include an IR remote controller receiver 181, a USS 182, a cliff PSD 183, an ARS 184, a bumper 185, and an OFS 186. The IR remote controller receiver 181 may include a sensor that receives a signal of an infrared (IR) remote controller for remotely controlling the robot. The ultrasonic sensor (USS) 182 may include a sensor for determining a distance between the obstacle and the robot using an ultrasonic signal. The cliff PSD 183 may include a sensor for sensing a precipice, a cliff, or the like in a 360-degree omnidirectional robot traveling range. The attitude reference system (ARS) 184 may include a sensor capable of tracking a posture of the robot. The ARS 184 may include a sensor composed of three axes of acceleration and three axes of gyro for tracking an amount of rotation of the robot. The bumper 185 may include a sensor that senses a collision between the robot and the obstacle.

The sensor included in the bumper 185 may sense the collision between the robot and the obstacle in a range of 360 degrees. The optical flow sensor (OFS) 186 may include a sensor capable of sensing a wheel slippage phenomenon during the travel of the robot and measuring a traveling distance of the robot on various floor surfaces.

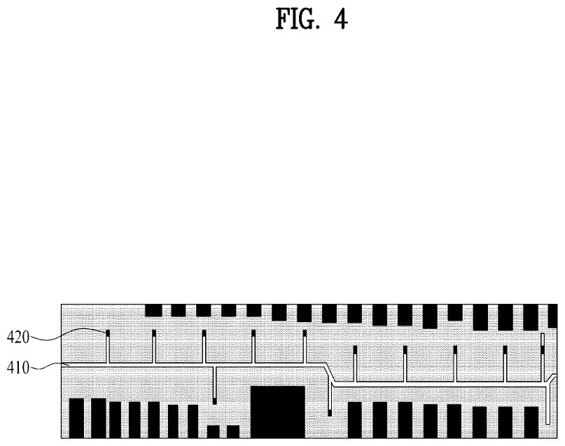

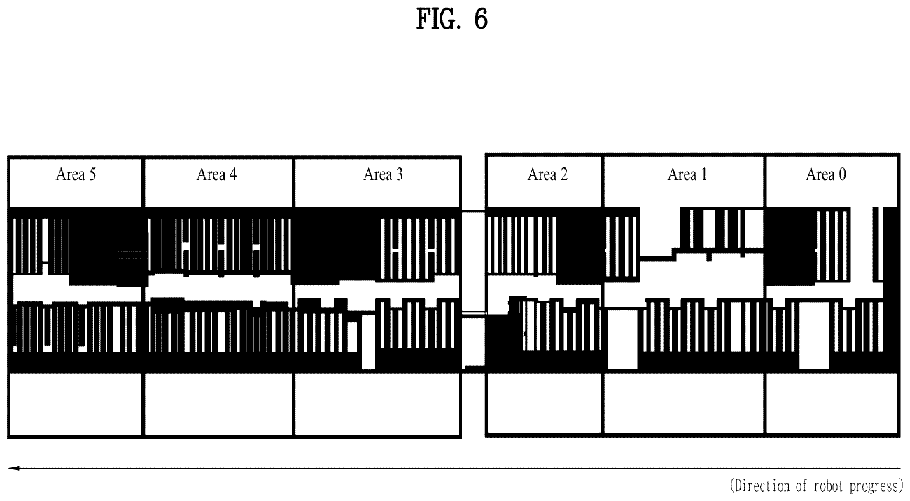

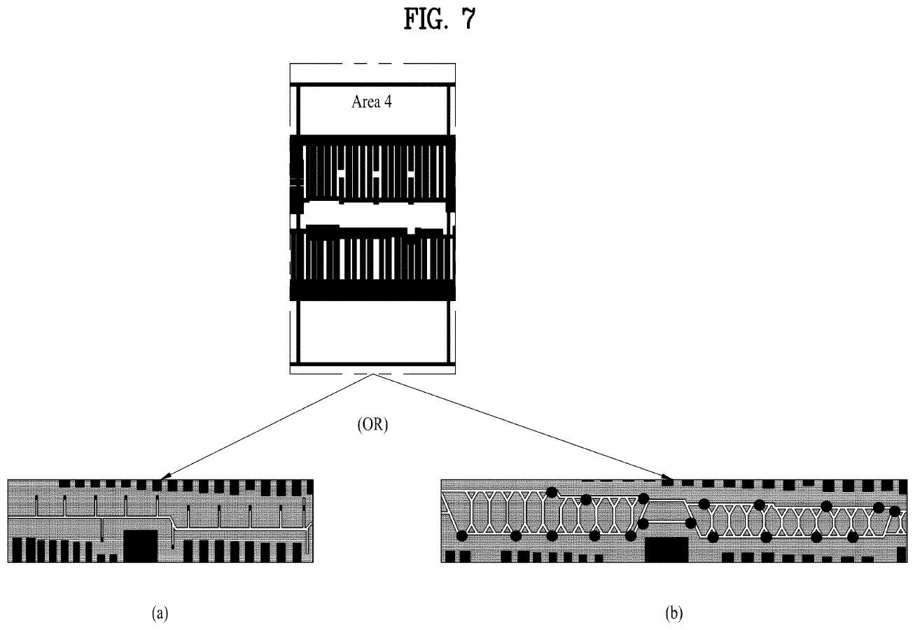

In particular, the present disclosure, as shown in FIG. 6, first divides the entire map into a plurality of areas. In addition, whenever the robot moves from a first area to a second area, which are connected to each other, the robot is designed to notify the server (e.g., an area switcher) of this, and the server (the area switcher) is designed to transmit a command for whether to use a one-lane road (e.g., FIG. 4) or a two-lane road (e.g., FIG. 1) when the robot moves within the corresponding area.

FIG. 4 illustrates a modified map according to an embodiment of the present disclosure.

According to the related art, as shown in FIG. 1, the robot is designed to travel only on the two-lane road that is the same and fixed on one map regardless of the area.

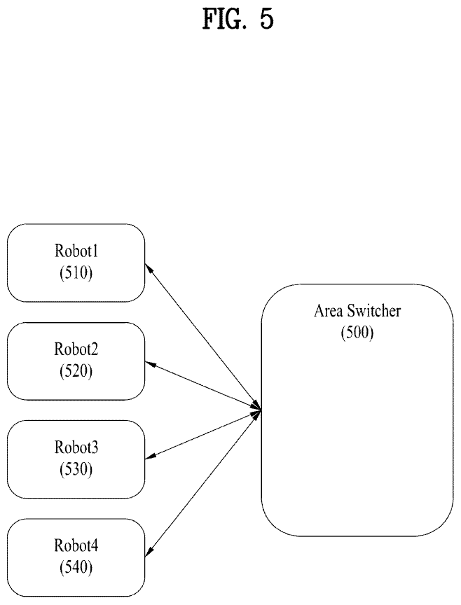

On the other hand, according to an embodiment of the present disclosure, the robot is designed to travel on a one-lane road 410 illustrated in FIG. 4 as well as on the two-lane road illustrated in FIG. 1 depending on a situation. Reference numeral 420 is a point of interest (POI), which means a point at which the robot may wait for a while. To implement the present disclosure, a process of communication between the robot and the server in a specific situation is very important, and a more specific embodiment related thereto will be described below in FIG. 5.

FIG. 5 illustrates an example of a server in communication with a robot according to an embodiment of the present disclosure.

As illustrated in FIG. 5, it is assumed that there are a plurality of robots 510, 520, 530, and 540 traveling in a certain map (e.g., the distribution center or the like).

Further, in this regard, each of the robots 510, 520, 530, and 540 is designed to perform bidirectional communication with an area switcher 500, which is an example of the server.

One of main functions of the server is to issue a permit for the robot to move from an arbitrary area to another area in the map. Therefore, a robot that has not received the permit is designed to wait without moving to the corresponding area.

Furthermore, the server serves to specify and inform a road to be used by the robot that has received the permit to enter the arbitrary area. The road herein corresponds to, for example, the two-lane road shown in FIG. 1 or the one-lane road shown in FIG. 4.

In addition, the server performs a role of identifying all movement flows of all the robots 510, 520, 530, and 540 and deriving an optimal flow. To implement the above, the server issues the permit for entering the specific area to the robot or causes the robot to wait by not issuing the permit.

Furthermore, one of other features of the present disclosure is to automatically switch between the two-lane road and the one-lane road for each area even in one map. In particular, switched lane information varies depending on the situation even in the same area. For example, it is designed to use the two-lane road in an area where two or more robots may cross, whereas the one-lane road is used in an area where only one robot travels.

In one example, although it has been described in the present document that only the one-lane road or the two-lane road may be used in the arbitrary area, but the concept may be extended to a three-lane road, a four-lane road, and the like, and the one-lane road may not be necessarily limited to the central lane and may be designed differently based on needs of those skilled in the art.

The present disclosure will be described in more detail from respective viewpoints of the server and the robot as follows.

First, a description will be made from the viewpoint of the server.

According to an embodiment of the present disclosure, a controller of the server (e.g., 500 shown in FIG. 5) creates the map on which at least one robot 510, 520, 530, or 540 may move.

Furthermore, the controller of the server identifies the created map as at least one area, which will be described in more detail later in FIG. 6.

In addition, a network interface of the server is designed to receive, from the at least one robot, a request for the permit to enter the arbitrary area and information on a lane on which the at least one robot will move in the corresponding area, and transmit, to the robot that has transmitted the request, the permit to enter the arbitrary area and the information on the lane on which the robot will move in the corresponding area.

In one example, the network interface of the server is designed to receive location information and destination information from all of the robots using the map (e.g., the specific distribution center). The reason for such a design is to determine whether it is advantageous in terms of travel speed and stability for a specific robot to use either the one-lane road or the two-lane road in the arbitrary area. A more specific embodiment related thereto will be described below in FIG. 6.

Accordingly, the controller of the server determines whether to issue the permit to enter the arbitrary area for the robot that has transmitted the request and the information on the lane on which the robot will move in the corresponding area, based on the received location information and destination information.

For example, when it is determined that the robot that has transmitted the request will travel alone in the arbitrary area, the controller of the server generates a command for controlling that one lane located at the center in the arbitrary area of the map is used.

On the other hand, when it is determined that another robot besides the robot that has transmitted the request will also travel together in the arbitrary area, the controller of the server generates a command for controlling that one of two lanes not located at the center in the arbitrary area of the map is used.

Now, a description will be made from the viewpoint of the robot.

According to an embodiment of the present disclosure, the robots 510, 520, 530, and 540 are also designed to be in communication with the server 500.

First, a controller of the arbitrary robot 510 controls the robot to travel on a map composed of a plurality of areas. The map composed of the plurality of areas will be described in more detail with reference to FIG. 6.

A network interface of the robot 510 transmits, to the server 500, the request for the permit to enter the arbitrary area and the information on the lane on which the robot will move in the arbitrary area before entering the arbitrary area.

In addition, the network interface of the robot 510 is designed to receive, from the server 500, the permit to enter the arbitrary area and the information on the lane on which the robot will move in the corresponding area.

The network interface of the robot 510 transmits the current location information and the destination information in the map to the server 500.

The controller of the robot controls the robot to travel on the one lane located at the center in the arbitrary area of the map based on a state of the arbitrary area.

On the other hand, the controller of the robot controls the robot to travel on one of the two lanes not located at the center in the arbitrary area of the map based on the state of the arbitrary area.

The state of the arbitrary area changes, for example, based on the number of robots to simultaneously travel or stop in the arbitrary area. A more specific embodiment related thereto will be described below with reference to FIG. 6.

FIG. 6 is a diagram illustrating that a full map on which a robot travels is subdivided into a plurality of areas according to an embodiment of the present disclosure.

FIG. 6 illustrates one map divided into six areas (area 0, area 1, area 2, area 3, area 4, and area 5). In one example, the map may be divided into a different number of areas based on the needs of those skilled in the art.

The robot according to an embodiment of the present disclosure should receive the permit from the server (e.g., the area switcher) whenever moving in and out of each area.

When area switching is required, the robot transmits a final destination (e.g., POI 33 in the area 5) to which it wants to go to the server.

Therefore, because the server knows the final destinations of all of the robots, the entire flow may be adjusted.

A description will be made with a more specific example.

It is assumed that a robot No. 1 is present in the area 0 and a final destination thereof is reported to the server as the area 3. In addition, it is assumed that a final destination of a robot No. 2 in the area 2 is reported to the server as the area 1.

In addition, it is assumed that two robots have already stopped in the area 1 and this is reported to the server.

In this case, the server is designed to give a priority pass to the robot No. 1. The reason is that the server already knows that the robot No. 1 will not stay in the area 1 but will pass up to the area 2.

On the other hand, because the robot No. 2 will stop in the area 1, when the robot No. 2 first enters the area 1, there is a possibility that the robot No. 1 may be obstructed in moving to the area 3 via the area 1. The design considers such possibility.

Further, FIG. 7 illustrates a process in which a robot switches map information in a specific area according to an embodiment of the present disclosure.

As described above, one of the main features of the present disclosure is not to uniformly use only lane information (e.g., two lanes) initially generated in the map, but to adaptively select lane information between the one-lane road ((a) in FIG. 7) and the two-lane road ((b) in FIG. 7) depending on a situation at a corresponding time point for each specific area in the map.

In such design, a number of technical effects are expected as follows.

First, according to an embodiment of the present disclosure, efficient movement of the robot is available.

When only one robot moves in the specific area, the robot does not need to move along an upper end or a lower end using the two-lane road shown in (b) in FIG. 7, and has an advantage of moving without being restricted by obstacles placed at the both ends only when moving along a center of the road ((a) in FIG. 7).

Second, according to another embodiment of the present disclosure, control of multiple robots is available.

All of the robots are designed to inquire with the server (e.g., the area switcher) whenever the area within the map changes, to check whether they are allowed to enter the corresponding area immediately and which lane to use. In this regard, after identifying the situations of the entire robots, when necessary, the server may stop the robots by not allowing them to directly enter the corresponding area, so that there is a technical effect that the movement flow of the entire robots may be smoothly made.

Third, according to still another embodiment of the present disclosure, the movement path may be diversified.

In the present document, it has been exemplarily described that one of the two-lane road map and the map of the one-lane road passing through the center is selected for each area, but a method of adding options for roads with three or more lanes for each situation and dynamically constructing the roads depending on the situation, such as the number of robots for each date, is also available.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

### Mode

Various forms (embodiments) for the implementation of the present disclosure have been fully described in the previous table of contents.

### Industrial Availability

Because the present disclosure is applicable to various types of robots, industrial applicability is recognized.

What is claimed is:

1. A method for controlling a server, the method comprising:
creating a map where at least one robot is movable;
identifying the created map as at least one area;
receiving, from the at least one robot, a request for a permit to enter an arbitrary area and information on a lane where the at least one robot is to move in the corresponding area; and
transmitting, to the robot that has transmitted the request, the permit to enter the arbitrary area and the information on the lane where the robot is to move in the corresponding area.

2. The method of claim 1, further comprising receiving location information and destination information from all robots using the map.

3. The method of claim 2, further comprising determining whether to permit the robot that has transmitted the request to enter the arbitrary area and the information on the lane where the robot is to move in the corresponding area, based on the received location information and destination information.

4. The method of claim 3, further comprising, when it is determined that the robot that has transmitted the request will travel alone in the arbitrary area, generating a command for controlling the robot to use one lane located at a center of the arbitrary area of the map.

5. The method of claim 4, further comprising, when it is determined that another robot besides the robot that has transmitted the request will also travel together in the arbitrary area, generating a command for controlling one of two lanes not located at the center of the arbitrary area of the map to be used.

6. A server comprising:
a controller configured to create a map where at least one robot is movable, and identify the created map as at least one area; and
a network interface configured to:
receive, from the at least one robot, a request for a permit to enter an arbitrary area and information on a lane where the at least one robot is to move in the corresponding area; and
transmit, to the robot that has transmitted the request, the permit to enter the arbitrary area and the information on the lane where the robot is to move in the corresponding area.

7. The server of claim 6, wherein the network interface is configured to receive location information and destination information from all robots using the map.

8. The server of claim 7, wherein the controller is configured to determine whether to permit the robot that has transmitted the request to enter the arbitrary area and the information on the lane where the robot is to move in the corresponding area, based on the received location information and destination information.

9. The server of claim 8, wherein the controller is configured to, when it is determined that the robot that has transmitted the request will travel alone in the arbitrary area, generate a command for controlling the robot to use one lane located at a center of the arbitrary area of the map.

10. The server of claim 9, wherein the controller is configured to, when it is determined that another robot besides the robot that has transmitted the request will also travel together in the arbitrary area, generate a command for controlling one of two lanes not located at the center of the arbitrary area of the map to be used.

11. A method for controlling a robot in communication with a server, the method comprising:
traveling on a map composed of a plurality of areas;
transmitting, to the server, a request for a permit to enter an arbitrary area and information on a lane where the robot is to move in the arbitrary area before entering the arbitrary area; and
receiving, from the server, the permit to enter the arbitrary area and the information on the lane where the robot is to move in the corresponding area.

12. The method of claim 11, further comprising transmitting, to the server, current location information and destination information in the map.

13. The method of claim 12, further comprising, depending on a state of the arbitrary area, traveling in one lane located at a center of the arbitrary area of the map.

14. The method of claim 13, further comprising, depending on the state of the arbitrary area, traveling in one of two lanes not located at the center of the arbitrary area of the map.

16. The method of claim 14, wherein the state of the arbitrary area varies based on the number of robots to simultaneously travel or stop in the arbitrary area.

16. A robot in communication with a server, the robot comprising:
a controller configured to control the robot to travel on a map composed of a plurality of areas; and
a network interface configured to:
transmit, to the server, a request for a permit to enter an arbitrary area and information on a lane where the robot is to move in the arbitrary area before entering the arbitrary area; and
receive, from the server, the permit to enter the arbitrary area and the information on the lane where the robot is to move in the corresponding area.

18. The robot of claim 16, wherein the network interface configured to transmit, to the server, current location information and destination information in the map.

18. The robot of claim 17, wherein the controller is configured to, depending on a state of the arbitrary area, control the robot to travel in one lane located at a center of the arbitrary area of the map.

19. The robot of claim 18, wherein the controller is configured to, depending on the state of the arbitrary area, control the robot to travel in one of two lanes not located at the center of the arbitrary area of the map.

20. The robot of claim 19, wherein the state of the arbitrary area varies based on the number of robots to simultaneously travel or stop in the arbitrary area.
